(19) United States
(12) Patent Application Publication
(10) Pub. No.: US 2017/0227815 A1
(43) Pub. Date: Aug. 10, 2017

(54) DISPLAY DEVICES, REFLECTIVE DISPLAY PANELS, AND THE REFLECTIVE UNITS THEREOF

(71) Applicant: Wuhan China Star Optoelectronics Technology Co., Ltd., Wuhan, Hubei (CN)

(72) Inventor: Chang XIE, Shenzhen, Guangdong (CN)

(73) Assignee: Wuhan China Star Optoelectronics Technology Co., Ltd., Wuhan, Hubei (CN)

(21) Appl. No.: 14/902,617

(22) PCT Filed: Dec. 30, 2015
(86) PCT No.: PCT/CN2015/099735

§ 371 Date: Jan. 4, 2016

(30) Foreign Application Priority Data
Dec. 16, 2015 (CN) 201510943289.5

(51) Int. Cl. G02F 1/1335; G02F 1/1333

(52) U.S. Cl. CPC G02F 1/133533; G02F 1/133553; G02F 1/133504; G02F 1/133308; G02F 2201/123; G02F 2203/02; G02F 2001/133314

(57) ABSTRACT

A display device, a reflective display panel and the reflective unit are disclosed. The reflective display panel includes a top substrate unit; a down substrate unit opposite to the top substrate unit; a liquid crystal layer arranged between the top substrate unit and the down substrate unit; a mirror reflective layer arranged at an inner side of the down substrate unit; a color-film polarizer unit arranged at an outer side of the top substrate unit; and wherein external light beams are reflected by the mirror reflective layer and pass through the color-film polarizer unit to generate diffused reflection effect. Compared to conventional technology, the cost of the mask may be reduced and the manufacturing process may be simplified. In this way, the defects are avoided and the reflection performance is enhanced.

### BACKGROUND OF THE INVENTION

1. Field of the Invention

The present disclosure relates to liquid crystal display technology, and more particularly to a display device, a reflective display panel, and the reflective unit thereof.

2. Discussion of the Related Art

As shown in FIG. 1, the liquid crystal display panel generally includes a color film (CF) substrate 10 and an array substrate (TFT substrate) 20 opposite to each other, and a liquid crystal (LC) layer is encapsulated between the two substrates.

As the liquid crystal molecules cannot emit lights themselves, and thus a light source is needed so as to display images. The liquid crystal device may include transmissive, reflective, and transflective type in accordance with the light source.

The reflective liquid crystal panel may adopt a front light source or an external light source. The array substrate thereof includes a reflective area, wherein the reflective electrodes are manufactured by metal or other material having good reflective attributes, and thus are suitable for reflecting the light beams from the front light source or the external light source. The power consumption of the reflective liquid crystal panel is relatively low for the reason that the external light source is utilized.

In order to obtain uniform reflection performance for every viewing angles, the reflection manner of the reflective layer 30 has to be diffused reflection, which is generally realized by uneven surfaces having micro-structures.

Specifically, a resin base is arranged on the reflective area, and a mask is adopted to perform array process, such as exposure, development, and etch. In this way, the uneven surface having micro-structures is formed on the resin base. The mask is needed for the manufacturing method to sputter the metallic layer, i.e., silver or aluminum, so as to form the reflective layer 30.

Thus, it can be understood that the mask process for manufacturing the reflective layer 30 results in additional manufacturing cost. In addition, the manufacturing precision of the micro-structure may cause defects such that the diffused reflection may be affected. Thus, a new solution is needed to overcome the above issue.

### SUMMARY

The object of the invention is to provide a display device, a reflective display panel, and the reflective unit thereof to overcome the high cost and bad performance issue regarding the micro-structures on the uneven surface of the resin base.

In one aspect, a reflective unit includes: a mirror reflective layer arranged at an inner side of the down substrate unit and a color-film polarizer unit arranged at an outer side of the top substrate unit, external light beams are reflected by the mirror reflective layer and pass through the color-film polarizer unit to generate diffused reflection effect.

In another aspect, a reflective display panel includes: a top substrate unit; a down substrate unit opposite to the top substrate unit; a liquid crystal layer arranged between the top substrate unit and the down substrate unit; a mirror reflective layer arranged at an inner side of the down substrate unit; a color-film polarizer unit arranged at an outer side of the top substrate unit; and wherein external light beams are reflected by the mirror reflective layer and pass through the color-film polarizer unit to generate diffused reflection effect.

Wherein the mirror reflective layer is a metallic layer.

Wherein the mirror reflective layer operates as a pixel electrode.

Wherein the color-film polarizer unit includes a polarizer base and a scattering layer having scattering particles.

Wherein the metallic layer is aluminum or silver.

In another aspect, a display device includes: a back frame module and a reflective display panel, the back frame module is configured to installing the reflective display panel, the reflective display panel includes: a top substrate unit; a down substrate unit opposite to the top substrate unit; a liquid crystal layer arranged between the top substrate unit and the down substrate unit; a mirror reflective layer arranged at an inner side of the down substrate unit; a color-film polarizer unit arranged at an outer side of the top substrate unit; and wherein external light beams are reflected by the mirror reflective layer and pass through the color-film polarizer unit to generate diffused reflection effect.

In view of the above, the uneven surface having micro-structures manufactured by the mask may be omitted. By the cooperative operations between the mirror reflective layer arranged at the inner side of the down substrate unit and the color-film polarizer unit arranged at the outer side of the top substrate unit, the diffused reflection effect may be generated, which ensures uniform reflection effect from every viewing angles. Compared to the conventional technology, the cost of the mask may be reduced and the manufacturing process may be simplified. In this way, the defects are avoided and the reflection performance is enhanced.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a schematic view showing the simplified structure of one conventional reflective display panel.

FIG. 2 is a schematic view showing the simplified structure of the reflective display panel in accordance with one embodiment.

FIG. 3 is a schematic view showing the simplified structure of the color-film polarizer of FIG. 2 in accordance with one embodiment.

FIG. 4 is a schematic view showing the simplified structure of the display panel in accordance with one embodiment.

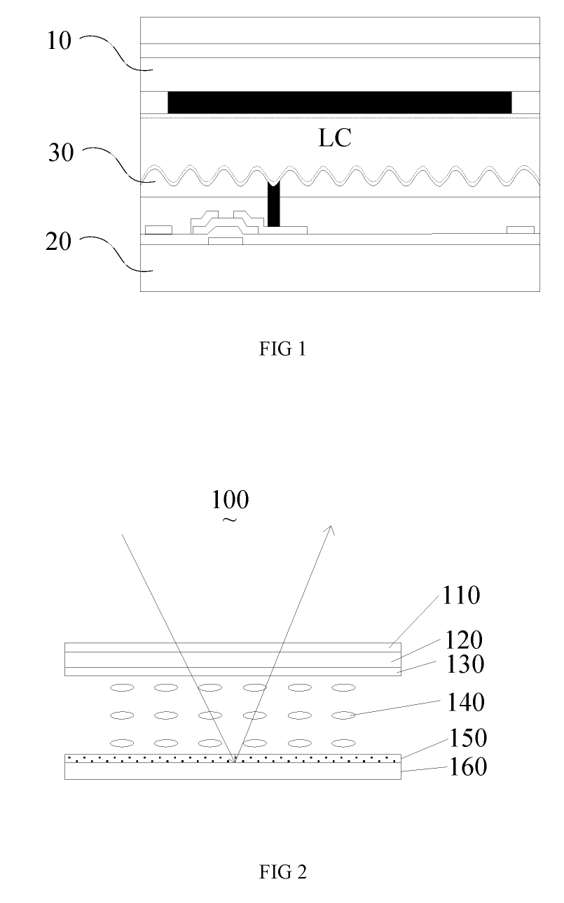

### DETAILED DESCRIPTION OF THE EMBODIMENTS

Embodiments of the invention will now be described more fully hereinafter with reference to the accompanying drawings, in which embodiments of the invention are shown.

FIG. 2 is a schematic view showing the simplified structure of the reflective display panel in accordance with one embodiment.

As shown in FIG. 2, the reflective display panel 100 includes a color-film polarizer unit 110, a color film substrate 120, a common electrode 130, a liquid crystal layer 140, a mirror reflective layer 150, and a TFT substrate 160 arranged along a top-down direction.

A top substrate unit includes the color film substrate 120 and the common electrode 130 stack together. The color film substrate 120 includes a glass substrate and a RGB layer arranged on the glass substrate in a matrix form. The common electrode 130 is a surface-electrode. Preferably, the common electrode 130 is made by indiumtin oxide film (ITO) characterized by the attributes such as transparent, good conductivity, good etching characteristics, and good reliability.

The down substrate unit is opposite to the top substrate unit. The down substrate includes the TFT substrate 160 manufactured by a plurality of etching processes.

The liquid crystal layer 140 includes a plurality of liquid crystal molecules filled between the top substrate unit and the down substrate unit via vacuum filling manner of one drop filling (ODF). After the liquid crystal materials are filled therebetween, sealant that can be cured by ultraviolet rays are adopted to seal the inlet.

The dimension of the mirror reflective layer 150 is the same with or close to that of the down substrate unit. The mirror reflective layer 150 is arranged at a lateral side of the down substrate unit. The external light beams pass through the top substrate unit and the down substrate unit and are reflected by the mirror reflective layer 150. After passing through the color-film polarizer unit 110, the diffused reflection effect may be generated. Wherein the dimension of the color-film polarizer unit 110 is the same with or close to that of the down substrate unit.

Specifically, the mirror reflective layer 150 is a metallic layer having a smooth surface without micro-structures for conducting the mirror reflection. Preferably, the mirror reflective layer 150 may operates as the pixel electrode. The pixel electrode may be a bar-shaped electrode. In an example, the pixel electrode may be an ITO film characterized by the attributes such as transparent, good conductivity, good etching characteristics, and good reliability.

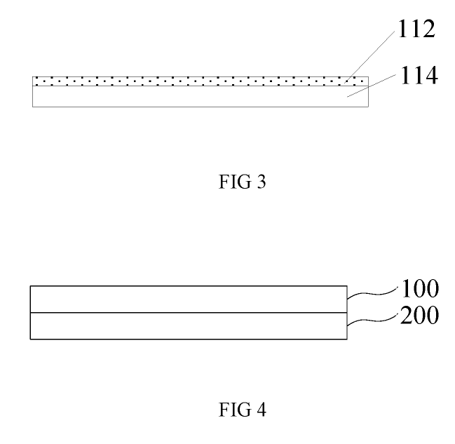

FIG. 3 is a schematic view showing the simplified structure of the color-film polarizer of FIG. 2 in accordance with one embodiment.

The color-film polarizer unit 110 includes a polarizer base 114 and a scattering layer 112. The dimension of the polarizer base 114 and the scattering layer 112 are the same with or close to that of the down substrate unit. The scattering layer 112 is configured with scattering particles. The scattering layer 112 may be implemented by adding the scattering particles into the outermost layer of the polarizer.

In addition, a reflective unit, as shown in FIG. 2, includes the mirror reflective layer 150 and the color-film polarizer unit 110. The mirror reflective layer 150 is arranged at an inner side of the down substrate unit. The color-film polarizer unit 110 is arranged at an outer side of the top substrate unit. The external light beams are reflected by the 140 are reflected by the 140 and then pass through the mirror reflective layer 150 to generate the diffused reflection effect. The structure of the mirror reflective layer 150 and the color-film polarizer unit 110 are the same with that of the reflective display panel 100, and thus are omitted hereinafter.

FIG. 4 is a schematic view showing the simplified structure of the display panel in accordance with one embodiment.

In one embodiment, the display device includes a back frame module 200 and the above reflective display panel 100. The back frame module 200 may be integrally formed or be assembled so as to fix the reflective display panel 100.

The top substrate unit, the down substrate unit, the back frame module 200, and other components may be referenced by conventional solutions, and thus are omitted hereinafter.

In view of the above, the uneven surface having micro-structures manufactured by the mask may be omitted. By the cooperative operations between the mirror reflective layer 150 arranged at the inner side of the down substrate unit and the color-film polarizer unit 110 arranged at the outer side of the top substrate unit, the diffused reflection effect may be generated, which ensures uniform reflection effect from every viewing angles. Compared to the conventional technology, the cost of the mask may be reduced and the manufacturing process may be simplified. In this way, the defects are avoided and the reflection performance is enhanced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A reflective unit, comprising:
a mirror reflective layer arranged at an inner side of the down substrate unit and a color-film polarizer unit arranged at an outer side of the top substrate unit, external light beams are reflected by the mirror reflective layer and pass through the color-film polarizer unit to generate diffused reflection effect.

2. The reflective unit as claimed in claim 1, wherein the mirror reflective layer is a metallic layer.

3. The reflective unit as claimed in claim 2, wherein the mirror reflective layer operates as a pixel electrode.

4. The reflective unit as claimed in claim 3, wherein the color-film polarizer unit comprises a polarizer base and a scattering layer having scattering particles.

5. The reflective unit as claimed in claim 4, wherein the metallic layer is aluminum or silver.

6. A reflective display panel, comprising:
a top substrate unit;
a down substrate unit opposite to the top substrate unit;
a liquid crystal layer arranged between the top substrate unit and the down substrate unit;
a mirror reflective layer arranged at an inner side of the down substrate unit;
a color-film polarizer unit arranged at an outer side of the top substrate unit; and
wherein external light beams are reflected by the mirror reflective layer and pass through the color-film polarizer unit to generate diffused reflection effect.

7. The reflective display panel as claimed in claim 6, wherein the mirror reflective layer is a metallic layer.

8. The reflective display panel as claimed in claim 7, wherein the mirror reflective layer operates as a pixel electrode.

9. The reflective display panel as claimed in claim 8, wherein the color-film polarizer unit comprises a polarizer base and a scattering layer having scattering particles.

10. The reflective display panel as claimed in claim 9, wherein the metallic layer is aluminum or silver.

11. A display device, comprising:
a back frame module and a reflective display panel, the back frame module is configured to installing the reflective display panel, the reflective display panel comprises:
a top substrate unit;
a down substrate unit opposite to the top substrate unit;
a liquid crystal layer arranged between the top substrate unit and the down substrate unit;
a mirror reflective layer arranged at an inner side of the down substrate unit;
a color-film polarizer unit arranged at an outer side of the top substrate unit; and
wherein external light beams are reflected by the mirror reflective layer and pass through the color-film polarizer unit to generate diffused reflection effect.

12. The display device as claimed in claim 11, wherein the mirror reflective layer is a metallic layer.

13. The display device as claimed in claim 12, wherein the mirror reflective layer operates as a pixel electrode.

14. The display device as claimed in claim 13, wherein the color-film polarizer unit comprises a polarizer base and a scattering layer having scattering particles.

15. The display device as claimed in claim 14, wherein the metallic layer is aluminum or silver.
